(19) United States
(12) Patent Application Publication
(10) Pub. No.: US 2007/0146545 A1
(43) Pub. Date: Jun. 28, 2007

(54) Image display apparatus

(75) Inventor: Toshiya Iwahashi, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/645,690

(22) Filed: Dec. 27, 2006

(30) Foreign Application Priority Data
Dec. 28, 2005 (JP) 2005-378665

(51) Int. Cl. H04N 5/44

(52) U.S. Cl. 348/553

(57) ABSTRACT

An image display apparatus including: an image quality adjustment section to adjust an image quality of the image displayed on the screen according to an alternation of an image quality adjustment parameter value, and to display on the screen at least one reference image having the image quality adjustment parameter value which differs from the image quality adjustment parameter of an original image before the alteration of the image quality adjustment parameter at the alteration of the image quality adjustment parameter value.

### BACKGROUND OF THE INVENTION

1. Field of the Invention

The present invention relates to an image display apparatus comprising a screen to display an image.

2. Description of Related Art

In the earlier development, there has been developed a multitude of an image display apparatuses such as a television receiver, which have a function of adjusting an image quality of the image displayed on a screen thereof by a user. In the image display apparatus having this function of image quality adjustment, the image quality is adjusted by an alteration of an image quality adjustment parameter value. However, not all users generally know the image quality adjustment parameter such as “BRIGHTNESS” and “SHARPNESS”, and the meaning of these image quality adjustment parameters is often uncertain for a user. Thus, a user may perform image quality adjustment operation without knowing an effect of the alteration of the image quality adjustment parameter on an image.

As for a technique for suitable image quality adjustment, for example, JP 2001-268475A discloses an image quality adjustment apparatus in which a display area is divided into left area and right area. The left part of an original image is displayed on the left area while the right part of an original image whose image quality is adjusted, to the right area, and a direction and a level of the adjustment is altered in this state. By doing so, it is disclosed that the most suitable adjustment state can be set easily and rapidly.

Moreover, JP 2002-152554A discloses a video reproduction apparatus in which a preview window is provided on a part of a menu window for alternation of an image quality adjustment parameter. When the image quality adjustment parameter is altered, video whose image quality is adjusted based on the altered image quality adjustment parameter is displayed only in the preview window, while the video before the alteration of the image quality adjustment parameter is displayed on the other area. By doing so, it is disclosed that the image quality adjustment parameter can be altered by comparing both videos, and the image quality of reproduced video can easily be adjusted in the video reproduction apparatus.

However, according to the image quality adjustment techniques disclosed in JP 2001-268475A and JP 2002-152554A, a user can recognize the effect of alteration of image quality adjustment parameter on the image only after the alteration of image quality adjustment parameter value. Therefore, a user may alter the image quality adjustment parameter value which need not be altered, and take unwanted trouble to get back to the original image. As a result, it was problematic that the operability of these apparatus was poor.

### SUMMARY OF THE INVENTION

It is an object of the present invention to provide an image display apparatus with which a user can recognize visually an effect of alteration of an image quality adjustment parameter value without alteration of the image quality adjustment parameter value, so that the operability of image quality adjustment operation is improved.

According to a first aspect of the present invention, an image display apparatus comprises: a screen to display an image; an image quality adjustment section to adjust an image quality of the image displayed on the screen according to an alternation of an image quality adjustment parameter value; a selection section to select one image quality adjustment parameter from a plurality of image quality adjustment parameters; an operation section to accept an operation to alter the image quality adjustment parameter value selected by the selection section, wherein the image quality adjustment section displays on the screen an original image before the alteration of the image quality adjustment parameter, and a first reference image having lager image quality adjustment parameter value than that of the original image and/or a second reference image having smaller image quality adjustment parameter value than that of the original image when the one image quality adjustment parameter is selected by the selection section, and the image quality adjustment section deletes the first reference image and/or the second reference image form the screen when the operation to alter the image quality adjustment parameter value is performed on the operation section.

Consequently, the image quality adjustment section displays on the screen the original image before the alteration of the image quality adjustment parameter, and the first reference image having lager image quality adjustment parameter value than that of the original image and/or the second reference image having smaller image quality adjustment parameter value than that of the original image when the one image quality adjustment parameter is selected by the selection section. Therefore, a user can compare the original image with the first and/or second reference image simultaneously. Thus, a user can visually comprehend the effect of the alteration of the image quality adjustment parameter value to the original image without actual alternation of the image quality adjustment parameter value. Consequently, a user can alter the image quality adjustment parameter to the most appropriate value more suitably. Moreover, the image quality adjustment section deletes the first reference image and/or the second reference image form the screen when the operation to alter the image quality adjustment parameter value is performed on the operation section. Therefore, there is no need for specific operation for displaying or deleting the reference image. Consequently, the operability of the image quality adjustment operation can be improved.

According to a second aspect of the present invention, an image display apparatus comprises: a screen to display an image; an image quality adjustment section to adjust an image quality of the image displayed on the screen according to an alternation of an image quality adjustment parameter value, wherein the image quality adjustment section displays on the screen at least one reference image having the image quality adjustment parameter value which differs from the image quality adjustment parameter of an original image before the alteration of the image quality adjustment parameter at the alteration of the image quality adjustment parameter value.

Consequently, the image quality adjustment section displays on the screen at least one reference image having the image quality adjustment parameter value which differs from the image quality adjustment parameter of the original image before the alteration of the image quality adjustment parameter at the alteration of the image quality adjustment parameter value. Therefore, by the reference image, a user can visually comprehend the effect of the alteration of the image quality adjustment parameter value to the original image without actual alternation of the image quality adjustment parameter value. Consequently, a user can alter the image quality adjustment parameter to the most appropriate value more suitably.

Preferably, the image quality adjustment section displays on the screen the original image, and a first reference image having lager image quality adjustment parameter value than that of the original image and/or a second reference image having smaller image quality adjustment parameter value than that of the original image, at the alteration of the image quality adjustment parameter value of the original image.

Consequently, the image quality adjustment section displays on the screen the original image, and the first reference image having lager image quality adjustment parameter value than that of the original image and/or the second reference image having smaller image quality adjustment parameter value than that of the original image, at the alteration of the image quality adjustment parameter value of the original image. Therefore, by the first and/or second reference image, a user can visually comprehend the effect of the alteration of making large and/or making small the image quality adjustment parameter value to the original image without actual alternation of the image quality adjustment parameter value.

Preferably, the image quality adjustment section displays the original image on whole of the screen, and displays the first reference image and/or the second reference image on a part of the screen with reduced size in picture-in-picture mode.

Consequently, the image quality adjustment section displays the original image on whole of the screen, and displays the first reference image and/or the second reference image on a part of the screen with reduced size in picture-in-picture mode. Therefore, a user can compare the original image with the first and/or second reference image simultaneously. Thus, a user can alter the image quality adjustment parameter to the most appropriate value more suitably.

Preferably, the image quality adjustment section displays the first reference image and/or the second reference image on whole of the screen, and displays the original image on a part of the screen in picture-in-picture mode.

Consequently, the image quality adjustment section displays the first reference image and/or the second reference image on whole of the screen, and displays the original image on a part of the screen in picture-in-picture mode. Therefore, a user can compare the original image with the first or second reference image simultaneously. Thus, a user can alter the image quality adjustment parameter to the most appropriate value more suitably.

Preferably, the image display apparatus further comprises: a selection section to select one image quality adjustment parameter from a plurality of image quality adjustment parameters, wherein the image quality adjustment section displays the reference image of the image quality adjustment parameter on the screen for a predetermined period of time when the image quality adjustment parameter is selected by the selection section, and deletes the reference image from the screen.

Consequently, the image quality adjustment section displays the reference image of the image quality adjustment parameter on the screen for a predetermined period of time when the image quality adjustment parameter is selected by the selection section, and deletes the reference image from the screen. Therefore, there is no need for specific operation for displaying or deleting the reference image. Consequently, the operability of the image quality adjustment operation can be improved.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a block diagram showing a composition of an image display apparatus according to a first embodiment of the present invention;

FIG. 2 is a block diagram showing a composition of a sub image processing unit according to the first embodiment;

FIG. 3 is an example of a screen based on an execution of a selection program according to the first embodiment;

FIG. 4A is an example of a screen based on an image quality adjustment program according to the first embodiment;

FIG. 4B is an example of the screen based on the image quality adjustment program according to the first embodiment;

FIG. 4C is an example of the screen based on the image quality adjustment program according to the first embodiment;

FIG. 4D is an example of the screen based on the image quality adjustment program according to the first embodiment;

FIG. 5 is a block diagram showing a composition of an image display apparatus according to a second embodiment of the present invention;

FIG. 6 is a block diagram showing a composition of a principal part of the sub image processing unit according to the second embodiment;

FIG. 7A is an example of a screen based on an image quality adjustment program according to the second embodiment;

FIG. 7B is an example of the screen based on the image quality adjustment program according to the second embodiment; and

FIG. 7C is an example of the screen based on the image quality adjustment program according to the second embodiment.

### DETAILED DESCRIPTION OF THE INVENTION

In the following, an embodiment of the present invention is described in detail by reference to the drawings.

A television receiver is given as the image display apparatus for the explanation in this embodiment.

### First Embodiment

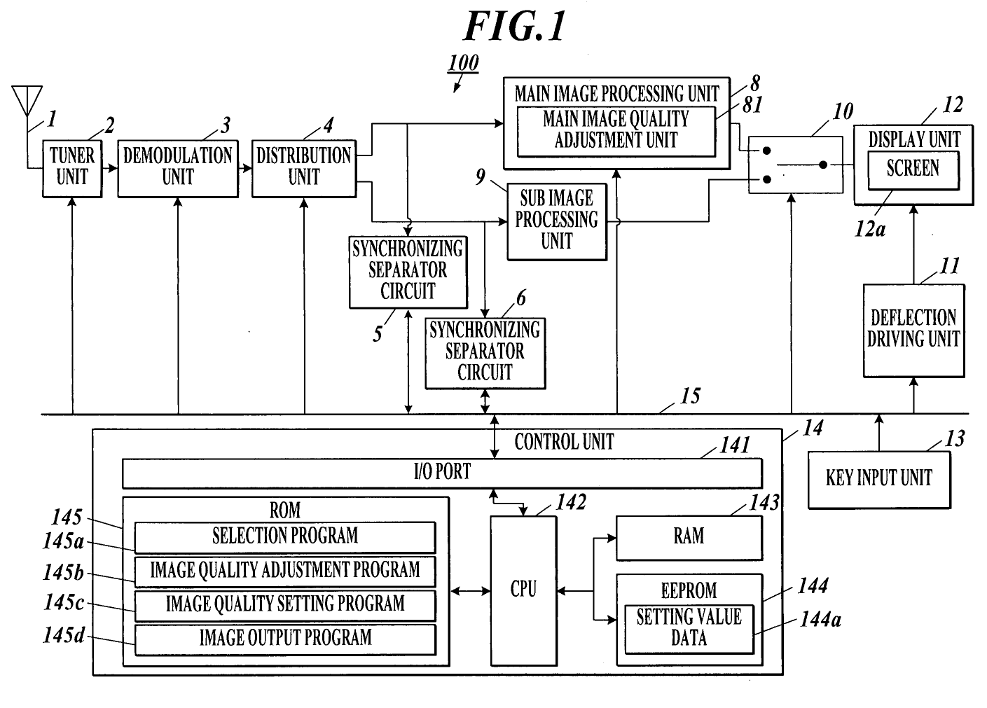

The television receiver 100 of the first embodiment has a function of image quality adjustment by which a user can adjust image quality of an image displayed on the screen 12a (see, FIG. 1). The image quality is adjusted by altering a value of an image quality adjustment parameter such as brightness and contrast and the like. At the alteration of the image quality parameter for an image quality adjustment, an image (an original image) before the alternation of the image quality parameter, i.e. before the image quality adjustment, is displayed on whole of the screen 12a. At the same time, an image (first reference image) having larger image quality parameter value and/or an image (second reference image) having smaller image quality parameter value are displayed with a reduced size in picture-in-picture (PIP) mode on a part of the screen 12a.

By comparing the original image and the first reference image and/or the second reference image which are displayed in picture-in-picture (PIP) mode on the screen 12a, a user can visually recognize the effect of the alternation of the image quality parameter value to the image without actual alternation of the image quality parameter value. Thus, a user can suitably alter the image quality adjustment parameter to the most appropriate value.

FIG. 1 is a block diagram showing a principal configuration of the television receiver 100 according to the first embodiment.

As shown in FIG. 1, the television receiver 100 of the first embodiment is, for example, provided with an antenna 1 to receive a broadcasting signal, a tuner unit 2 to tune a broadcasting signal of predetermined frequency input by the antenna 1, a demodulation unit 3 to demodulate the broadcasting signal tuned by the tuner unit 2, a distribution unit 4 to distribute the video signal demodulated by the demodulation unit 3 to a main image processing unit 8 and a sub image processing unit 9, a synchronizing separator circuit 5 to separate a synchronizing signal from the video signal output to the main image processing unit 8 by the distribution unit 4, a synchronizing separator circuit 6 to separate a synchronizing signal from the video signal output to the sub image processing unit 9 by the distribution unit 4, the main image processing unit 8 to perform predetermined image processing to the video signal input from the demodulation unit 3 through the distribution unit 4, the sub image processing unit 9 to perform predetermined image processing to the video signal input from the demodulation unit 3 through the distribution unit 4, a synthesis unit 10 to synthesize the video signal input from the main image processing unit 8 and the video signal input from the sub image processing unit 9, a deflection driving unit 11 to control deflection at a display unit 12, the display unit 12 to display an image based on the video signal input from the synthesis unit 10, a key input unit 13 to accept key operation of a user, a control unit 14 to control the whole television receiver 100 integrally, a control bus 15 to connect each units one another, and the like.

The antenna 1 is, for example, placed outdoors in the direction of predetermined direction and receives a radio-frequency (RF) video signal transmitted from a television broadcasting station (not shown).

The tuner unit 2 picks up the video signal of specific frequency band from the video signal received by the antenna 1, converts it into an intermediate frequency (IF) signal having predetermined intermediate frequency, and outputs it to the demodulation unit 3, according to a control signal from the control unit 14.

The demodulation unit 3 amplifies the intermediate frequency signal input from the tuner unit 2 and distributes it into a video intermediate frequency signal and an audio intermediate frequency signal, and detects the video intermediate signal gained by the separation to take out a video signal and output it to the distribution unit 4.

The distribution unit 4 distributes the video signal detected at the demodulation unit 3 to the main image processing unit 8 and the sub image processing unit 9.

Here, a video signal for generating the original image is input to the main image processing unit 8, and a video signal for generating the first reference image and/or the second reference image is input to the sub image processing unit 9.

These video signals for the original image and the first reference image and/or the second reference image input to the main image processing unit 8 and the sub image processing unit 9 respectively are the same signal. For example, each of these signals is generated by separation at the distribution unit 4 of the video signal received by the antenna 1.

In addition, under normal processing other than the image quality adjustment, the video signal is input to the main image processing unit 8.

The synchronizing separator circuit 5 picks up a vertical synchronizing signal and a horizontal synchronizing signal from the video signal for the original image input to the main image processing unit 8, and output them to the control unit 14. The synchronizing separator circuit 6 picks up a vertical synchronizing signal and a horizontal synchronizing signal respectively from the video signal for the first reference image and/or the video signal for the second reference image, and output them to the control unit 14. To put it concretely, the synchronizing separator circuits 5 and 6 pick up the vertical synchronizing signal and the horizontal synchronizing signal by cutting off a video signal with cutoff characteristics of transistor using an amplitude difference between a synchronizing signal and a video signal.

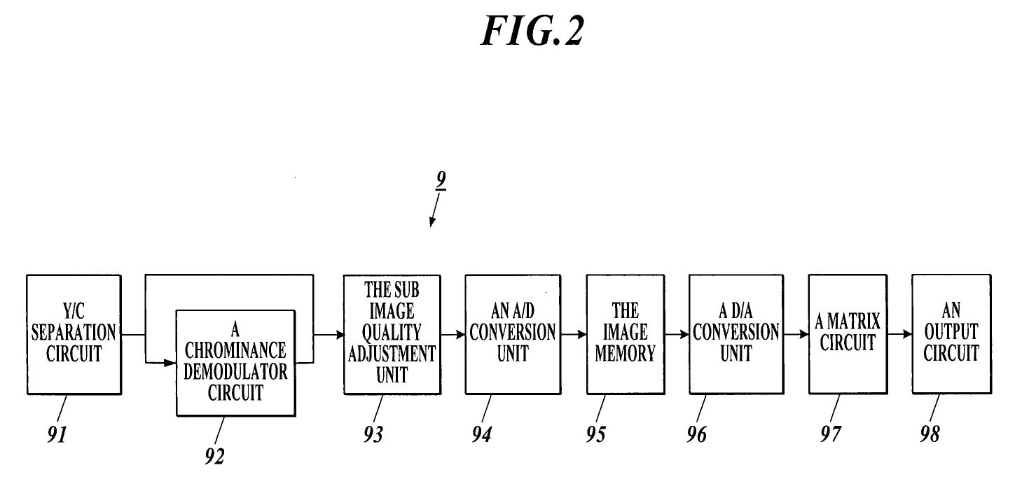

The control unit 14 generates a synthesis control signal for controlling the synthesis unit 10, based on the video signal for the original image which is input from the synthesis synchronizing separator circuit 5, and outputs it to the synthesis unit 10. The control unit 14 generates a timing control signal for controlling a timing for writing to an image memory 95 (see, FIG. 2), based on the vertical synchronizing signal and the horizontal synchronizing signal separated from the video signal(s) for the first and/or second reference image which is input from the synthesis separator circuit 6. In addition, the control unit 14 generates a timing control signal for controlling a timing for reading from the image memory 95, based on the vertical synchronizing signal and the horizontal synchronizing signal separated from the video signal for the original image which is input from the synchronizing separator circuit 5. The control unit 14 outputs these timing control signals to the sub image processing unit 9.

The sub image processing unit 9 performs predetermined image processing to the video signal(s) for the first and/or second reference image input from the distribution unit 4 to generate RGB signal(s), and output it to the synthesis unit 10.

To put it concretely, as shown in FIG. 2, the sub image processing unit 9 is provided with, for example, a Y/C separation circuit 91, a chrominance demodulator circuit 92, the sub image quality adjustment unit 93, an A/D conversion unit 94, the image memory 95, a D/A conversion unit 96, a matrix circuit 97, an output circuit 98, and the like.

The Y/C separation circuit 91 separates and picks up a brightness signal Y and a chrominance signal C from the input video signal. The brightness signal Y separated by the Y/C separation circuit 91 is output to the sub image quality adjustment circuit 93, while the chrominance signal C is output to the chrominance demodulator circuit 92.

The chrominance demodulator circuit 92 demodulates the chrominance signal C input from the Y/C separation circuit 91 to R-Y, B-Y and G-Y color difference signals, and output them to the sub image quality adjustment unit 93.

The sub image quality adjustment unit 93 performs various image quality adjustments of brightness, contrast, color density, hue, sharpness, and the like, to the brightness signal Y separated by the Y/C separation circuit 91 and to the R-Y, B-Y, G-Y color difference signals demodulated by the chrominance demodulator circuit 92, based on the image quality adjustment signal output from the control unit 14.

To put in concretely, the sub image quality adjustment unit 93 performs brightness adjustment, contrast adjustment, sharpness adjustment, and the like to the brightness signal Y, and performs color density adjustment, hue adjustment, and the like to the R-Y, B-Y, G-Y color difference signals.

The A/D conversion unit 94 converts the brightness signal Y and the R-Y, B-Y, G-Y color difference signals into digital signals and output them to the image memory 95.

The image memory 95 is composed of, for example, a field memory and the like, and a data input from the A/D conversion unit 94 is written to it. The image memory 95 stores the data based on the video signal for the first reference image and the data based on the video signal for the second reference image respectively in different areas thereof.

The writing to the image memory 95 is performed at a timing based on the timing control signal, which is generated by the control unit 14 based on the vertical synchronizing signal and the horizontal synchronizing signal separated from the video signal(s) for the first and/or second reference image (s). That is, the writing to the image memory 95 synchronizes with the synchronizing signal(s) of the first and/or second reference image(s), and the screen size(s) of the first and/or second reference image is reduced by tinning out a scanning line at the time of the writing to the image memory 95. Meanwhile, the reading out from the image memory 95 is performed at a timing based on the timing control signal which is generated by the control unit 14 based on the vertical synchronizing signal and the horizontal synchronizing signal separated from the video signal for the original image.

The D/A conversion unit 96 converts data read from the image memory 95 to an analog signal, and outputs it to the matrix circuit 97.

The matrix circuit 97 generates RGB three primary color signals by matrixing the brightness signal Y and the R-Y, B-Y, G-Y color difference signals. The RGB signals generated by the matrix circuit 97 are subject to a predetermined process such as encoding at the following output circuit 98, and output to the synthesis unit 10.

The main image processing circuit 8 is provided with a Y/C separation circuit (not shown), a main image quality adjustment unit 81, a chrominance demodulator circuit (not shown), a matrix circuit (not shown) and an output circuit (not shown), performs predetermined image processing to the video signal for the original image to generate the RGB signals and outputs them to the synthesis unit 10.

The main image processing unit 8 performs various image quality adjustments such as brightness, contrast, color density, hue, sharpness, and the like, by the main image quality adjustment circuit 81, to the brightness signal Y separated by the Y/C separation circuit and the R-Y, B-Y, G-Y color difference signals demodulated by the chrominance demodulator circuit, based on an image quality adjustment signal output from the control unit 14.

Incidentally, the Y/C separation circuit, the chrominance demodulator circuit, the matrix circuit and the output circuit have same configurations as those of the sub image processing unit 9 described above. Thus, the explanation thereof is omitted here.

The synthesis unit 10 synthesizes an image by switching an input between the RGB signals for the original image input from the main image processing unit 8 and the RGB signals for the first or second reference image input from the sub image processing unit 9, according to the synthesis control signal from the control unit 14.

To put it concretely, the synthesis unit 10 inserts the video signal for the first and/or second reference image to the video signal for the original image by switching connection to between the main image processing unit 8 and the sub image processing unit 9, according to predetermined timing based on the synthesis control signal generated by the video signal for the original image which is input from the synchronizing separator circuit 5, and outputs it to the display unit 12 as a synthesized signal. As a consequence, the original image is displayed on whole of the screen 12a, while the first and/or second reference image is displayed in picture-in-picture (PIP) mode with a reduced size on a part of the original image displayed on whole of the screen 12a.

The deflection driving unit 11 controls the deflection of the display unit 12 according to the vertical deflection signal and the horizontal deflection signal generated by the control unit 14 based on the vertical synchronizing signal and the horizontal synchronizing signal input from the synchronizing separator circuit 5.

To put it concretely, the deflection driving unit 11, for example, applies a saw-tooth wave current to a horizontal and a vertical deflection coil(s) (not shown) equipped to the display unit 12 based on the vertical synchronizing signal and the horizontal synchronizing signal which are input from the synchronizing separator circuit 5, and controls vertical direction and horizontal direction of an electron beam emitted from an electron gun (not shown).

The display unit 12 is provided with the display screen 12a and the like. When the electron beams emitted from the three electron guns of R, G and B collide with a fluorescent screen (not shown) composed of a crystal grain which glows by collision of the electron beam, an image based on the synthesis signal output from the synthesis unit 10 is displayed on the screen 12a.

The key input unit 13 is, for example, provided with various keys (not shown) such as an up-down key. When each key is pushed, a corresponding input operation signal is input to the control unit 14. The key input unit 13 functions as the operation section and the selection section.

The control unit 14 is provided with an I/O port 141, a central processing unit (CPU) 142, a random access memory (RAM) 143, an electronically erasable and programmable read only memory (EEPROM) 144, a read only memory (ROM) 145, and the like.

The CPU 142 controls the whole operation of the television receiver 100 integrally by executing various programs stored in the ROM 145 according to an input signal input from each unit of the television receiver 100 through the control bus 15 and the I/O port 141, and outputting a control signal based on execution of the various programs to each unit through the I/O port 141 and the control bus 15.

The RAM 143 is, for example, a volatile semiconductor memory. The RAM 143 temporarily stores a processing result generated under execution of various programs by the CPU 142, and stores input data. The RAM 143 functions as a work area of the CPU 142.

The EEPROM 144 is, for example, a rewritable semiconductor memory. The EEPROM 144 stores a setting value data 144a which stores each image quality adjustment value set by a user, according to execution of an image quality adjustment program 145b (described below) by the CPU 142.

Moreover, although not shown in the drawings, the EEPROM 144 may store an initial setting value of each image quality adjustment value in another area, for example.

The ROM 145 is, for example, a nonvolatile semiconductor memory. The ROM 145 stores various control programs executed by the CPU 142 and data relating to processing of the control programs. To put it concretely, the ROM 145 stores control programs such as a selection program 145a, the image quality adjustment program 145b, an image quality setting program 145c, an image output program 145d, and the like.

The selection program 145a, for example, makes the CPU 142 realize the function of selecting one image quality adjustment parameter from a plurality of image quality adjustment parameters.

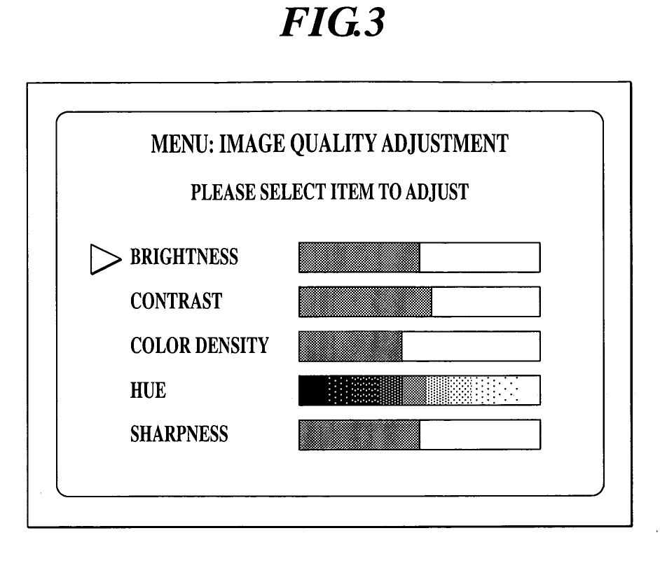

To put it concretely, the CPU 142 displays a menu screen for a user to select one image quality parameter to be altered from a plurality of image quality adjustment parameters, according to an input operation signal input to the control unit 14 based on a push-down operation of the key operation unit 13 by a user. As shown in FIG. 3, a list of alterable image quality parameters such as brightness, contrast, color density, hue, sharpness, and the like, is displayed on the menu screen. When a user selects an item of desired image quality parameter by operating the key operation unit 13, an input operation signal based on the selection operation is input to the control unit 14, and the image quality parameter is stored as a selected image quality parameter.

The CPU 142 functions as the selection section along with the key operation unit 13 by executing the selection program 145a.

The image quality adjustment program 145b, for example, makes the CPU 142 realize the function of adjusting the image quality of an image displayed on the display screen 12a based on the alteration of the image quality adjustment parameter value. To put it concretely, the image quality adjustment program 145b, when one image quality adjustment parameter is selected by the execution of the selection program 145a, makes the CPU 142 display the original image before the alteration of the image quality adjustment parameter on whole of the screen 12a, and display the first reference image having larger image quality adjustment parameter value than that of the original image and/or the second reference image having smaller image quality adjustment parameter value than that of the original image on a part of the screen 12a with a reduced size. Moreover, the image quality adjustment program 145b, when a key operation for altering the image quality adjustment parameter value by the key input unit 13 is made, makes the CPU 142 delete the first and/or the second reference image from the screen 12a.

In addition, the image quality adjustment program 145b, when one image quality adjustment parameter is selected by the execution of the selection program 145a, and the original image and the first and/or second reference image are displayed on the screen 12a, makes the CPU 142 display the reference image for the image quality adjustment parameter value for a predetermined period of time (for example, 5 seconds) on the screen 12a, and delete it thereafter, even when no operation for altering the image quality adjustment parameter value is made.

Next, the processing of the CPU 142 under the image quality adjustment program 145b is described more specifically.

The CPU 142, when one image quality adjustment parameter is selected by a user under the execution of the selection program 145a, performs image quality adjustment processing to the video signal for the original image by outputting an image quality adjustment signal for image quality adjustment aiming to make the selected image quality adjustment of the image be the value of the setting value data 144a which is stored in the EEPROM 144, to the main image quality adjustment unit 81. The CPU 142 also performs a process as described above by each following unit, and outputs it to the display unit 12.

Moreover, by outputting the image quality adjustment signal for image quality adjustment aiming to set the selected image quality adjustment parameter value to the largest value to the sub image quality adjustment unit 93, the CPU 142 converts the video signal for the first reference image whose screen size has been reduced by the timing control of writing to the image memory 95, to be a video signal having the largest image quality adjustment parameter value. Further, by outputting the image quality adjustment signal for image quality adjustment aiming to set the selected image quality adjustment parameter value to the smallest value to the sub image quality adjustment unit 93, the CPU 142 converts the video signal for the second reference image whose screen size has been reduced by the timing control of writing to the image memory 95, to be a video signal having the smallest image quality adjustment parameter value. Then, the CPU 142 performs the process to the video signal for the first reference image which has been converted to have the largest image quality adjustment parameter and/or to the video signal for the second reference image which has been converted to have the smallest image quality adjustment parameter, as described above by each following unit, and outputs them to the display unit 12.

As the consequence of these processings by the CPU 142, the original image before the alteration of the image quality adjustment parameter is displayed on whole of the screen 12a. At the same time, the first reference image having the largest image quality adjustment parameter value and/or the second reference image having the smallest image quality adjustment parameter value is displayed with a reduced size in picture-in-picture (PIP) mode on a part of the original image displayed on whole of the screen 12a.

Moreover, in the state where the original image and the first and/or second reference image displayed in picture-in-picture (PIP) mode on the screen 12a, when a user operates the key input unit 13 such as the operation of the up-down key (not shown) and the like for altering the image quality adjustment parameter value, or after a predetermined period of time has been passed, the CPU 142 deletes the first and/or the second reference image from the screen 12a. That is, after the beginning of the operation of the key input unit 13 by a user for altering the image quality adjustment parameter value, or after the predetermined period of time, only the processing for the video signal which is input to the main image quality processing unit 8 is performed by each unit of the television receiver 100 described above.

The CPU 142 functions as the image quality adjustment section by executing the image quality adjustment program 145b.

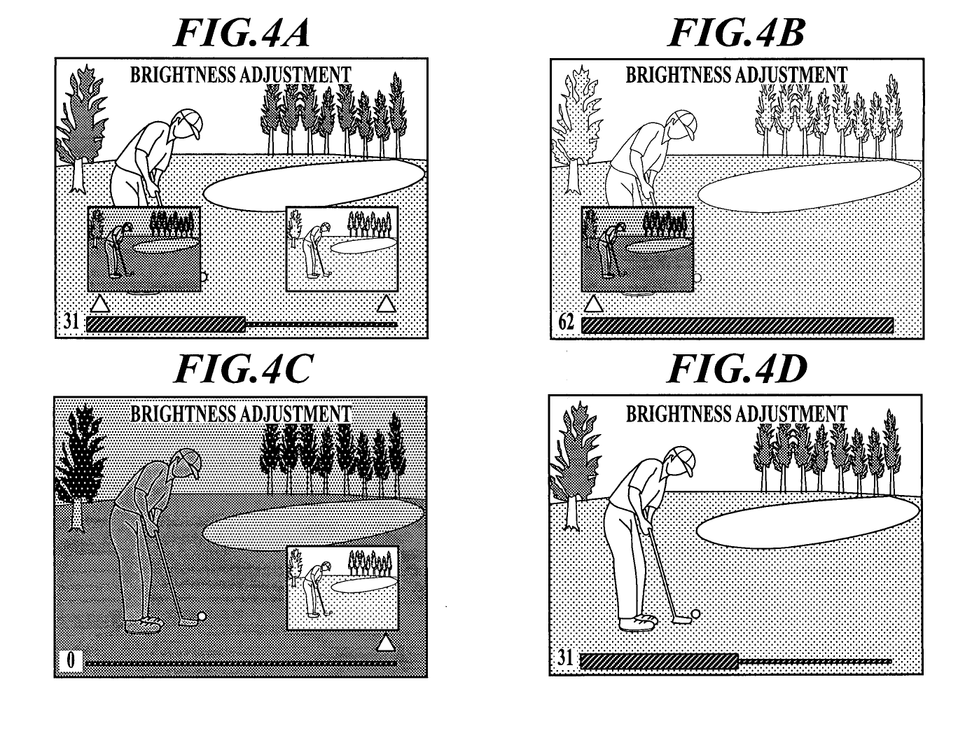

The FIGS. 4A to 4D are views illustrating a display of the screen 12a when a user selects one image quality adjustment parameter under the execution of the image quality adjustment program 145b by the CPU 142.

For example, when a user selects the “brightness” parameter by the operation of the key input unit 13 under the execution of the image quality adjustment program 145b, the input operation signal based on the selection operation is output to the control unit 14. Then, as shown in FIG. 4A, the CPU 142 displays the original image before the alteration of the brightness value br (for example, br=31) on the whole screen 12a. At the same time, the CPU 142 displays the first reference image having the largest brightness value br (for example, br=62) on a lower right part of the original image with reduced size, and also displays the second reference image having the smallest brightness value br (for example, br=0) on a lower left part of the original image with reduced size. Here, the original image is an image subjected to image processing by the main image quality adjustment unit 81 according to the brightness value br (for example, br=31) of the setting value data 144a which is stored in the EEPROM 144 by the execution of the image quality setting program 145c described later.

When the brightness value br of the original image based on the setting value data 144a is the largest value (for example, br=62), the CPU 142 displays the original image on the whole screen 12a together with the second reference image having the smallest brightness value (for example, br=0) with reduced size on lower left part of the original image, but does not display the first reference image as shown in FIG. 4B. Furthermore, when the brightness value of the original image based on the setting value data 144a is the smallest value (for example, br=0), the CPU 142 displays the original image on the whole screen 12a, together with the first reference image having the largest brightness value (for example, br=62) with reduced size on lower right part of the original image, but does not display the second reference image as shown in FIG. 4C.

Then, when a user operates the key input unit 13 such as the up-down key and the like, the CPU 142 deletes the first and/or second reference image displayed on the lower right part and/or the lower left part of the original image as shown in FIG. 4D.

Thereafter, when the key input unit 13 is operated to alter the image quality adjustment parameter in the state where the original image displayed on the screen 12a, the CPU 142 outputs the image quality adjustment signal based on this operation to the main image quality adjustment unit 81 to perform image quality adjustment processing to the video signal which is input to the main image processing unit 8, and display it to the screen 12a.

The image quality setting program 145c, for example, makes the CPU 142 realize the function of storing in the EEPROM 144 the setting of the image quality adjustment parameter value determined by the user's operation of the key input unit 13. The setting value data 144a stored in the EEPROM 144 by the execution of the image quality setting program 145c by the CPU 142 is referred to during the execution of the image quality adjustment program 145b by the CPU 142, and the image quality adjustment processing based on the setting value data 144a is performed to the video signal for the original image by the main image quality adjustment unit 81. Further, the setting value data 144a stored in the EEPROM 144 by the execution of the image quality setting program 145c by the CPU 142 is referred to during the execution of the image output program 145d by the CPU 142, and the image quality adjustment processing based on the setting value data 144a is performed to the video signal by the main image quality adjustment unit 81.

The image output program 145d, for example, makes the CPU 142 realize the function of performing image quality adjustment such as brightness, contrast, and the like to the video signal, by outputting a predetermined image quality adjustment signal to the main image quality adjustment 81, based on the setting value data 144a stored in the EEPROM 144 by the execution of the image quality adjustment program 145b.

By the execution of the image output program 145d, an image based on the image quality adjustment parameter value set by a user is displayed on the screen 12a.

According to the television receiver 100 of the first embodiment of the present invention, when one image quality adjustment parameter is selected from the plurality of the image quality adjustment parameter by the execution of the selection program 145a, the CPU 142 executes the image quality adjustment program 145b so that the original image before the alteration of the image quality adjustment parameter value and the first reference image having larger image quality adjustment parameter value and/or the second reference image having smaller image quality adjustment parameter value are displayed on the screen 12a. Therefore, a user can compare the original image with the first and/or second reference image simultaneously. Thus, a user can visually comprehend the effect of the alteration of the image quality adjustment parameter value to the original image without actual alternation of the image quality adjustment parameter value. Consequently, a user can alter the image quality adjustment parameter to the most appropriate value more suitably.

Moreover, when the operation for altering one image quality adjustment parameter is performed by a user operating the key input unit 13, or after a predetermined period of time has been passed, the first reference image and/or the second reference image is deleted from the screen 12a. Therefore, there is no need for specific operation for displaying or deleting the reference image. Consequently, the operability of the image quality adjustment operation can be improved.

### Second Embodiment

Next, a television receiver 200 of the second embodiment of the present invention is described. In the explanation, common parts with the first embodiment are severally denoted by the same reference numerals, and description is given only to the different parts.

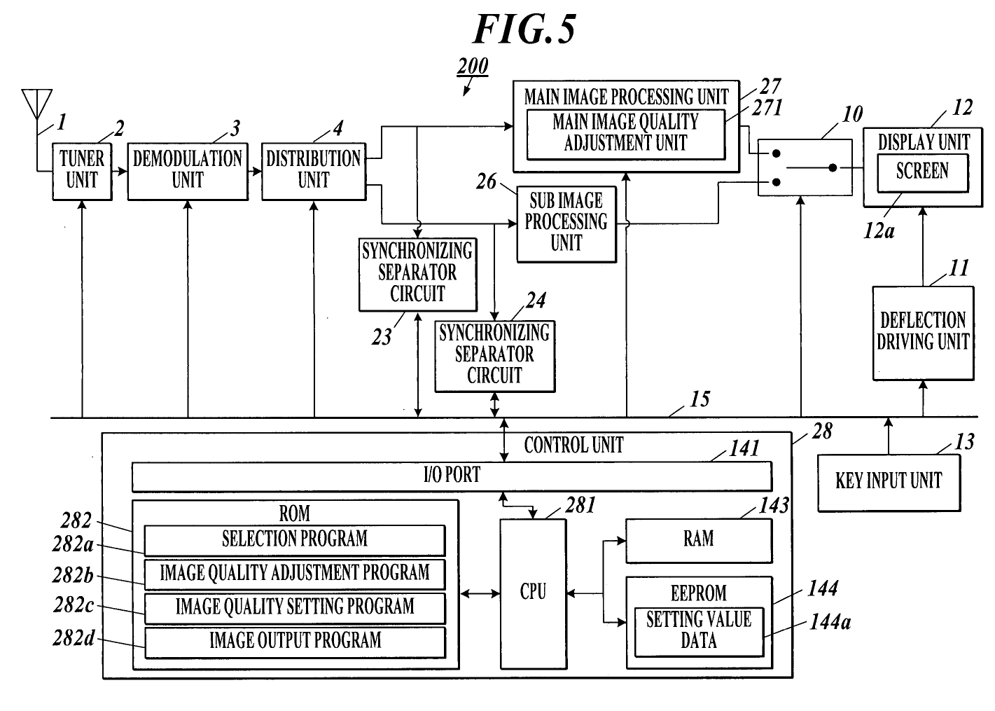

The television receiver 200 of the second embodiment has a function of image quality adjustment by which a user can adjust image quality of an image displayed on the screen 12a (see, FIG. 5). The image quality is adjusted by altering a value of an image quality adjustment parameter such as brightness, contrast and the like. In the alteration of the image quality adjustment parameter for an image quality adjustment, an image (first reference image) having larger image quality adjustment parameter value, or an image (second reference image) having smaller image quality adjustment parameter value, is displayed on whole of the screen 12a. At the same time, an image (an original image) before the alteration of the image quality adjustment parameter, i.e. before the image quality adjustment, is displayed with a reduced size in picture-in-picture (PIP) mode on a part of the screen 12a. By comparing the original image with the first reference image or the second reference image which is displayed in picture-in-picture (PIP) mode on the screen 12a, a user can visually comprehend the effect of the alternation of the image quality adjustment parameter value to the image without actual alternation of the image quality adjustment parameter value. Thus, a user can alter the image quality adjustment parameter to the most appropriate value more suitably.

As shown in FIG. 5, the television receiver 200 of the second embodiment is, for example, provided with an antenna 1 to receive a broadcasting signal, a tuner unit 2 to tune a broadcasting signal of predetermined frequency input by the antenna 1, a demodulation unit 3 to demodulate the broadcasting signal tuned by the tuner unit 2, a distribution unit 4 to distribute the video signal demodulated by the demodulation unit 3 to a main image processing unit 27 and a sub image processing unit 26, a synchronizing separator circuit 23 to separate a synchronizing signal from the video signal output to the main image processing unit 27 by the distribution unit 4, a synchronizing separator circuit 24 to separate a synchronizing signal from the video signal output to the sub image processing unit 26 by the distribution unit 4, the main image processing unit 27 to perform predetermined image processing to the video signal input from the demodulation unit 3 through the distribution unit 4, the sub image processing unit 26 to perform predetermined image processing to the video signal input from the demodulation unit 3 through the distribution unit 4, a synthesis unit 10 to synthesize the video signal input from the main image processing unit 27 and the video signal input from the sub image processing unit 26, a deflection driving unit 11 to control deflection at a display unit 12, the display unit 12 to display an image based on the video signal input from the synthesis unit 10, a key input unit 13 to accept key operation of a user, a control unit 28 to control the whole television receiver 200 integrally, a control bus 15 to connect these units one another, and the like.

The video signal for the original image is input to the sub image processing unit 26, and the video signal for the first or second reference image is input to the main image processing unit 27.

These video signals for the original image, the first reference image and the second reference image which are input to the main image processing unit 27 and the sub image processing unit 26 respectively are the same signal. For example, each of these signals is generated by separation of the video signal received by the antenna 1 by the distribution unit 4.

Incidentally, under normal-processing other than the image quality adjustment, the video signal is input to the main image processing unit 27.

The sub image processing unit 26 performs predetermined image processing to the video signal(s) for the original image input from the distribution unit 4 to generate RGB signal(s), and output it to the synthesis unit 10.

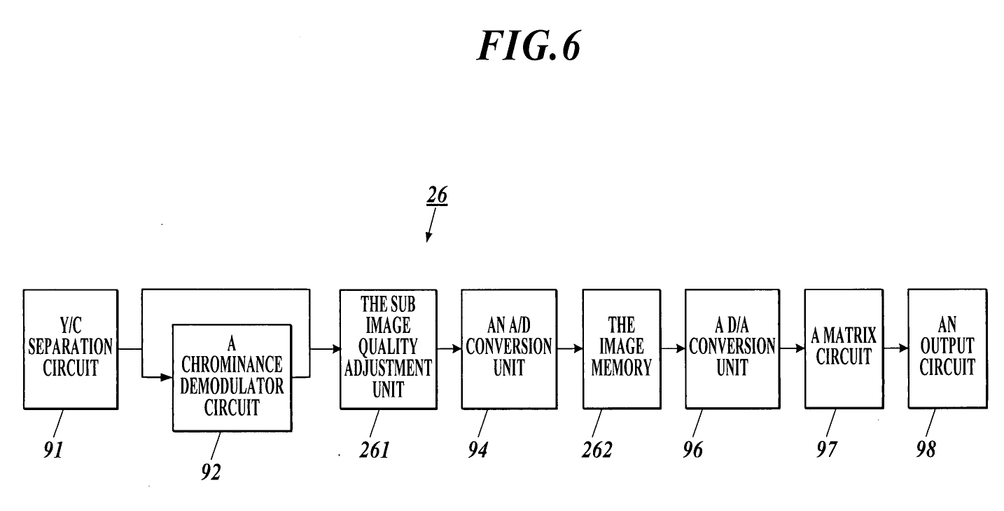

To put it concretely, as shown in FIG. 6, the sub image processing unit 26 is provided with, for example, a Y/C separation circuit 91, a chrominance demodulator circuit 92, a sub image quality adjustment unit 261, an A/D conversion unit 94, the image memory 262, a D/A conversion unit 96, a matrix circuit 97, an output circuit 98, and the like.

The image memory 262 is composed of, for example, a field memory and the like, and a data input from the A/D conversion unit 94 is written to it. That is, the image memory 262 stores the data based on the video signal for the original image.

The writing to the image memory 262 is performed based on the timing control signal which is generated by the control unit 28 based on the vertical synchronizing signal and the horizontal synchronizing signal separated from the video signal(s) for the original image(s). That is, the writing to the image memory 262 synchronizes with the synchronizing signal(s) of the original image(s), and the screen size(s) of the original image is reduced by tinning out a scanning line at the time of the writing to the image memory 262. Meanwhile, the reading out from the image memory 262 is performed based on the timing control signal which is generated by the control unit 28 based on the vertical synchronizing signal and the horizontal synchronizing signal separated from the video signal for the first or second reference image.

The main image processing circuit 27 is provided with, a Y/C separation circuit (not shown), a main image quality adjustment unit 271, a chrominance demodulator circuit (not shown), a matrix circuit (not shown), an output circuit (not shown). The main image processing circuit 27 performs image quality adjustment processing to the video signal for the first or second reference image to generate the RGB signals and outputs them to the synthesis unit 10.

The main image processing unit 27 performs various image quality adjustments such as brightness, contrast, color density, hue, sharpness and the like, by the main image quality adjustment circuit 271, to the brightness signal Y separated by the Y/C separation circuit, and to the R-Y, B-Y, G-Y color difference signals demodulated by the chrominance demodulator circuit, according to an image quality adjustment signal output from the control unit 28.

The synthesis unit 10 synthesizes an image by switching an input between the RGB signals for the first or second reference image from the main image processing unit 27 and the RGB signals for the original image from the sub image processing unit 26, based on the synthesis control signal from the control unit 28.

To put it concretely, the synthesis unit 10 inserts the video signal for the original image to the video signal for the first or second reference image by switching connection to between the main image processing unit 27 and the sub image processing unit 26, according to predetermined timing based on the synthesis control signal generated based on the video signal for the original image which is input from the synchronizing separator circuit 23, and outputs it to the display unit 12 as a synthesized signal. As a consequence, the first or second reference image is displayed on whole of the screen 12a, while the original image is displayed in picture-in-picture (PIP) mode with a reduced size on a part of the first or the second reference image displayed on whole of the screen 12a.

The control unit 28 is provided with an I/O port 141, a central processing unit (CPU) 281, a random access memory (RAM) 143, an electronically erasable and programmable read only memory (EEPROM) 144, a read only memory (ROM) 282, and the like.

The CPU 281 controls the whole operation of the television receiver 200 integrally by executing various programs stored in ROM 282 according to an input signal from each unit of the television receiver 200 through the control bus 15 and the I/O port 141, and by outputting a control signal based on execution of various programs to each unit through the I/O port 141 and the control bus 15.

The ROM 282 is, for example, a nonvolatile semiconductor memory. The ROM 282 stores various control programs executed by the CPU 281 and data relating to a processing of various control programs. To put it concretely, the ROM 282 stores control programs such as a selection program 282a, the image quality adjustment program 282b, an image quality setting program 282c, an image output program 282d, and the like.

The selection program 282a, for example, makes the CPU 281 realize the function of selecting one image quality adjustment parameter from a plurality of image quality adjustment parameters.

To put it concretely, the CPU 281 displays a menu screen for a user to select one image quality adjustment parameter to alter from a plurality of image quality adjustment parameters, according to an input operation signal input to the control unit 28 based on an operation of the key operation unit 13 by a user. As shown in FIG. 3, a list of alterable image quality adjustment parameters such as brightness, contrast, color density, hue, sharpness, and the like, is displayed on the menu screen. When a user select an item of desired image quality adjustment parameter by operation of the key operation unit 13, an input operation signal based on the selection operation is input to the control unit 28, and one image quality adjustment parameter is stored as a selected image quality adjustment parameter.

The CPU 281 functions as the selection section together with the key input unit 13 by executing the selection program 282a.

The image quality adjustment program 282b, for example, makes the CPU 281 realize the function of adjusting the image quality of an image displayed on the display screen 12a, based on the alteration of the image quality adjustment parameter value. To put it concretely, the image quality adjustment program 282b, when one image quality adjustment parameter is selected by the execution of the selection program 282a, makes the CPU 281 display the original image before the alteration of the image quality adjustment parameter on a part of the screen 12a with a reduced size, and display the first reference image having larger image quality adjustment parameter value than that of the original image or the second reference image having smaller image quality adjustment parameter value than that of the original image on whole of the screen 12a. Moreover, when a key operation on the key input unit 13 for altering the image quality adjustment parameter value is made, the image quality adjustment program 282b makes the CPU 281 delete the first or second reference image from the screen 12a.

In addition, when one image quality adjustment parameter is selected by the execution of the selection program 282a and the original image and the first or second reference image is displayed on the screen 12a, the image quality adjustment program 282b makes the CPU 281 realize a function of displaying the reference image having the image quality adjustment parameter value for a predetermined period of time (for example, 5 seconds) on the screen 12a, and delete it thereafter, even if there is no operation for altering the image quality adjustment parameter value.

Next, the processing of the CPU 281 under the image quality adjustment program 282b is described more specifically.

When one image quality adjustment parameter is selected by a user under the execution of the selection program 282a, the CPU 281 converts the video signal for the first reference image to the video signal having the largest image quality adjustment value by outputting an image quality adjustment signal to make the selected image quality adjustment parameter value the largest to the main image quality adjustment unit 271, and converts the video signal for the second reference image to the video signal having the smallest image quality adjustment value by outputting an image quality adjustment signal to make the selected image quality adjustment parameter value the smallest to the main image quality adjustment unit 271. Then, the CPU 281 performs a processing as described above by the units at the following step to the video signal for the first reference image whose image quality adjustment parameter value is converted to the largest, and to the video signal for the second reference image whose image quality adjustment parameter value is converted to the smallest, and outputs them to the display unit 12 alternately at predetermined time intervals.

Moreover, by outputting the image quality adjustment signal to make the selected image quality adjustment parameter value be the value of the setting value data 144a which is stored in the EEPROM 144 to the sub image quality adjustment unit 261, the CPU 281 performs image quality adjustment processing to the video signal for the original image whose screen size is reduced by the timing control to the writing to the image memory 95. The CPU 281 performs a processing as described above by the units at the following step to the video signal, and outputs it to the display unit 12.

As the consequence of these processing by the CPU 281, the first reference image having the largest image quality adjustment parameter value is displayed on whole of the screen 12a, and the original image before the alteration of the image quality adjustment parameter is displayed with a reduced size in picture-in-picture (PIP) mode on a part of the first reference image displayed on whole of the screen 12a. In addition, after the predetermined period of time, the second reference image having the smallest image quality adjustment parameter value is displayed on whole of the screen 12a, and the original image before the alteration of the image quality adjustment parameter in displayed with a reduced size in picture-in-picture (PIP) mode on a part of the second reference image displayed on whole of the screen 12a.

Moreover, when the original image and the first or second reference image is displayed in picture-in-picture (PIP) mode on the screen 12a, and a user operates the key input unit 13 for altering the image quality adjustment parameter value such as the operation of the up-down key (not shown) and the like, or after a predetermined period of time, the CPU 281 deletes the first or second reference image from the screen 12a and displays the original image before the alteration of the image quality adjustment parameter on whole of the screen 12a. That is, after a user operates the key input unit 13 for altering the image quality adjustment parameter value, or after the predetermined period of time has been passed, only the process for the video signal which is input to the main image quality processing unit 27 is performed by each of the above-described units of the television receiver 200.

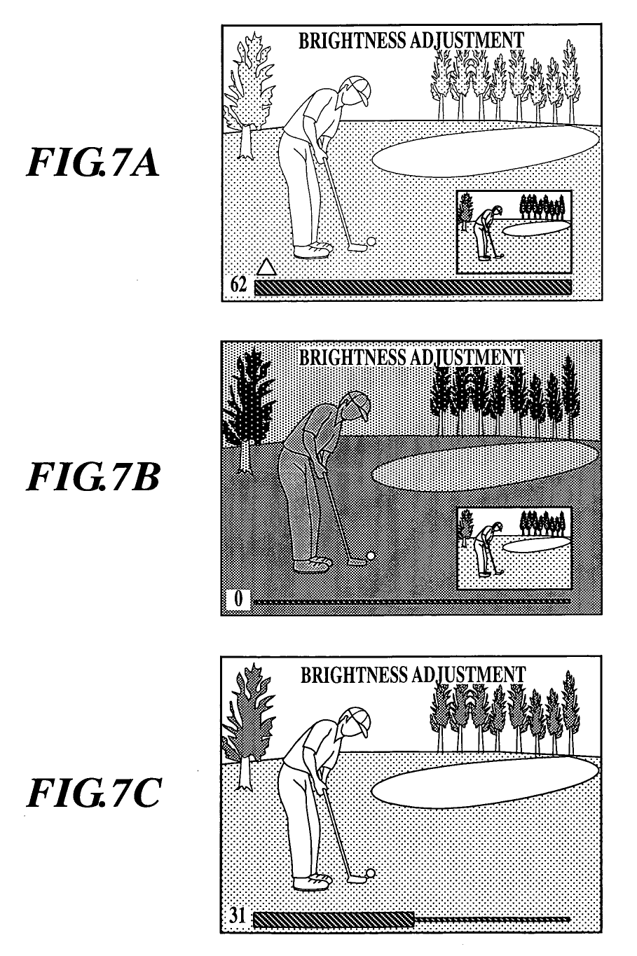

The FIGS. 7A to 7C are views illustrating a display of the screen 12a when one image quality adjustment parameter is selected by a user under the execution of the image quality adjustment program 282b by the CPU 281.

For example, when the “brightness” parameter is selected by operation of the key input unit 13 by a user under the execution of the image quality adjustment program 282b, and the input operation signal based on this selection operation is output to the control unit 28, as shown in FIG. 7A, the CPU 281 displays the first reference image having the largest brightness value br (for example, br=62) on the whole screen 12a, and at the same time, displays the original image before the alteration of the brightness value br (for example, br=31) on a lower right part of the first reference image with reduced size. In addition, after a predetermined period of time (for example, 3 seconds), as shown in FIG. 7B, the CPU 281 displays the second reference image having the smallest brightness value br (for example, br=0) on the whole screen 12a, and at the same time, displays the original image before the alteration of the brightness value br (for example, br=31) on a lower right part of the second reference image with reduced size. Furthermore, after a predetermined period of time (for example, 3 seconds), the CPU 281 put the screen 12a back to the state in which the first reference image is displayed on the whole screen 12a as shown in FIG. 7A. Here, the original image has been subjected to image quality processing by the main image quality adjustment unit 271 based on the brightness value br (for example, br=31) of the setting value data 144a which is stored in the EEPROM 144 under the execution of the image quality setting program 282c described hereinbelow.

Then, when the operation of the key input unit 13 such as the up-down key and the like is made by a user, as shown in FIG. 7C, the CPU 281 deletes the first or second reference image displayed and the original image displayed with reduced size on the screen 12a, and furthermore, displays the original image on the whole screen 12a.

Thereafter, when the operation for altering the image quality adjustment parameter of the key input unit 13 is made with the original image displayed on the screen 12a, the CPU 281 outputs the image quality adjustment signal based on this operation to the main image quality adjustment unit 271 to perform image quality adjustment processing based on this operation to the video signal which is input to the main image processing unit 27, and display it to the screen 12a.

The image quality setting program 282c, for example, makes the CPU 281 realize the function of storing in the EEPROM 144 the setting of the image quality adjustment parameter value decided by the operation of the key input unit 13 by a user. The setting value data 144a stored in the EEPROM 144 by the execution of the image quality setting program 282c by the CPU 281 is referred to during the execution of the image quality adjustment program 282b by the CPU 281, and the image quality adjustment processing is performed based on the setting value data 144a to the video signal for the original image by the sub image quality adjustment unit 261. In addition, the setting value data 144a is referred to during the execution of the image output program 282d by the CPU 281, and the image quality adjustment processing is performed based on the setting value data 144a to the video signal by the main image quality adjustment unit 271.

The image output program 282d, for example, makes the CPU 281 realize the function of performing image quality adjustment such as brightness, contrast, and the like to the video signal by outputting predetermined image quality adjustment signal to the main image quality adjustment 271, based on the setting value data 144a stored in the EEPROM 144 by the execution of the image quality adjustment program 282b.

By the execution of the image output program 282d, an image based on the image quality adjustment parameter value set by a user is displayed on the screen 12a.

According to the television receiver 200 described above, when one image quality adjustment parameter is selected from the plurality of the image quality adjustment parameter by the execution of the selection program 282a, CPU 281 executes the image quality adjustment program 282b so that the original image before the alteration of the image quality adjustment parameter value and the first reference image having larger image quality adjustment parameter value or the second reference image having smaller image quality adjustment parameter value are displayed on the screen 12a. Therefore, a user can compare the original image with the first or second reference image simultaneously so that a user can visually recognize the effect of the alteration of the image quality adjustment parameter value to the original image without actual alternation of the image quality adjustment parameter value. Consequently, a user can alter the image quality adjustment parameter to the most appropriate value more suitably.

Moreover, when the operation for altering one image quality adjustment parameter is performed by the operation of the key input unit 13 by a user, or after a predetermined period of time, the first and/or second reference image is deleted from the screen 12a. Therefore, there is no need for specific operation for displaying or deleting the reference image, and the operability of the image quality adjustment operation can be improved.

In addition, the present invention is not limited to the embodiments described above, and can be suitably modified and altered within the spirit of the invention.

For example, although the first and second reference images are generated using a broadcasting signal as the original image in the embodiments, data for generating the first and second reference images and original image may be stored in the ROM 145, 282 previously.

Moreover, although the television receiver 100, 200 are given as the image display apparatus in the first and second embodiments, an image displayed on a screen may be generated by a Digital Versatile Disc (DVD) player, or a Personal Computer (PC), for example.

Furthermore, although the original image before the alternation of the image quality adjustment parameter and the first and/or second reference image are displayed on the screen 12a in the first and second embodiments, the number of reference image displayed on screen, the image quality adjustment parameter value of the reference image, and display method and the like are not limited to these embodiments.

Moreover, the image quality adjustment parameter, which is alterable by a user, is not limited to brightness, contrast, color density, hue, sharpness and the like. The image quality adjustment parameter may be, for example, color temperature, black correction, gamma correction and the like.

Furthermore, although the video signal is distributed to a plurality of video signals by the distribution unit 4 in the first and second embodiments, a plurality of tuner units 2 may be equipped so as to perform processing to different video signals input to respective tuner units via different routes, or may generate a plurality of video signals by switching in predetermined timing so as to separate a video signal to a plurality of video signals by time difference.

The entire disclosure of Japanese Patent Application No. 2005-378665 filed on Dec. 28, 2005, including description, claims, drawings and summary is incorporated herein by reference in its entity.

What is claimed is:

1. An image display apparatus, comprising:
a screen to display an image;
an image quality adjustment section to adjust an image quality of the image displayed on the screen according to an alternation of an image quality adjustment parameter value;
a selection section to select one image quality adjustment parameter from a plurality of image quality adjustment parameters;
an operation section to accept an operation to alter the image quality adjustment parameter value selected by the selection section,
wherein the image quality adjustment section displays on the screen an original image before the alteration of the image quality adjustment parameter, and a first reference image having lager image quality adjustment parameter value than that of the original image and/or a second reference image having smaller image quality adjustment parameter value than that of the original image when the one image quality adjustment parameter is selected by the selection section, and
the image quality adjustment section deletes the first reference image and/or the second reference image form the screen when the operation to alter the image quality adjustment parameter value is performed on the operation section.

2. An image display apparatus, comprising:
a screen to display an image;
an image quality adjustment section to adjust an image quality of the image displayed on the screen according to an alternation of an image quality adjustment parameter value,
wherein the image quality adjustment section displays on the screen at least one reference image having the image quality adjustment parameter value which differs from the image quality adjustment parameter of an original image before the alteration of the image quality adjustment parameter at the alteration of the image quality adjustment parameter value.

3. The image display apparatus as claimed in claim 1, wherein the image quality adjustment section displays on the screen the original image, and a first reference image having lager image quality adjustment parameter value than that of the original image and/or a second reference image having smaller image quality adjustment parameter value than that of the original image, at the alteration of the image quality adjustment parameter value of the original image.

4. The image display apparatus as claimed in claim 3, wherein the image quality adjustment section displays the original image on whole of the screen, and displays the first reference image and/or the second reference image on a part of the screen with reduced size in picture-in-picture mode.

5. The image display apparatus as claimed in claim 3, wherein the image quality adjustment section displays the first reference image and/or the second reference image on whole of the screen, and displays the original image on a part of the screen in picture-in-picture mode.

6. The image display apparatus as claimed in claim 2, further comprising:
a selection section to select one image quality adjustment parameter from a plurality of image quality adjustment parameters,
wherein the image quality adjustment section displays the reference image of the image quality adjustment parameter on the screen for a predetermined period of time when the image quality adjustment parameter is selected by the selection section, and deletes the reference image from the screen.
